(19) United States
(12) Patent Application Publication
(10) Pub. No.: US 2014/0067887 A1
(43) Pub. Date: Mar. 6, 2014

(54) Grid Computing System Alongside A Distributed File System Architecture

(71) Applicants: Oliver Schabengerger, Cary, NC (US); Steve Krueger, Raleigh, NC (US); Karl Moss, Raleigh, NC (US)

(72) Inventors: Oliver Schabengerger, Cary, NC (US); Steve Krueger, Raleigh, NC (US); Karl Moss, Raleigh, NC (US)

(73) Assignee: SAS Institute Inc., Cary, NC (US)

(21) Appl. No.: 13/597,585

(22) Filed: Aug. 29, 2012

(51) Int. Cl. G06F 17/30

(52) U.S. Cl. 707/827; 707/E17.01

(57) ABSTRACT

Systems and methods are provided for a grid computing system that performs analytical calculations on data stored in a distributed file system. A grid-enabled software component at a control node is configured to invoke the distributed file system software at the control node to provide block locations for a plurality of the data blocks; determine a configuration of data blocks to read at the plurality of worker nodes; instruct the grid-enabled software components at the plurality of worker nodes to retrieve locally stored data, perform an analytical calculation on the retrieved data, and send the results of the analytical calculation on the retrieved data to the grid-enabled software component at the control node; and assemble the results of the analytical calculations performed by the grid-enabled software components from the plurality of worker nodes.

### TECHNICAL FIELD

The technology described herein relates generally to distributed data processing and more specifically to distributed data processing using grid-based computing systems and distributed file systems.

### BACKGROUND

High-performance analytic solutions involve co-locating data and analytic code. This can reduce I/O overhead because large amounts of data can be loaded into memory across a grid of nodes and parallel computing can take place.

### SUMMARY

In accordance with the teachings provided herein, systems and methods are provided for a grid computing system that performs analytical calculations on data stored in a distributed file system. For example, a grid-enabled software component executes on a control node and provides commands to a plurality of worker node grid-enabled software components. Each of the worker node grid-enabled software components are associated with and execute on a separate node. The node also executes file management software (FMS) that manage data on which analytical calculations or querying or load activity may be performed. The grid-enabled software component at the control node is configured to invoke the distributed file system software at the control node to provide block locations for a plurality of the data blocks; determine a configuration of data blocks to read at the plurality of worker nodes; instruct the grid-enabled software components at the plurality of worker nodes to retrieve locally stored data, perform an analytical calculation on the retrieved data, and send the results of the analytical calculation on the retrieved data to the grid-enabled software component at the control node; and assemble the results of the analytical calculations performed by the grid-enabled software components from the plurality of worker nodes.

These aspects and other embodiments may include one or more of the following features. The grid-enabled software components at the worker nodes can be configured to retrieve locally stored data by memory mapping the local storage media. The grid-enabled software components at the worker nodes can be configured to store the results from the analytical calculations in the respective local storage media. The worker node grid-enabled software components can be configured to send the results of the analytical calculations to the control node grid-enabled software component via a network. The worker node grid-enabled software components can be configured to transmit their results using a Message Passing Interface (MPI) over the network. The control node grid-enabled software component can be configured to store the assembled results in the distributed file system. The control node grid-enabled software component can be configured to transmit the assembled results to a grid-enabled software component at a client node. Based upon a determination that one of the worker nodes experiences a failure: the grid-enabled software component at the control node can be configured to instruct the grid-enabled software component at one of the other worker nodes to retrieve a portion of the data previously retrieved by the grid-enabled software component at the node that was determined to have experienced the failure; the grid-enabled software component instructed to retrieve the previously retrieved data can be configured to perform an analytical calculation on the previously retrieved data and provide the results to the grid-enabled software component at the control node; and the grid-enabled software component at the control node can be configured to assemble the results received from the grid-enabled software components at the other worker nodes. The system can include a grid-enabled software component at a client node, where the client node grid-enabled software component can be configured to invoke the grid-enabled software component at the control node to perform the analytical calculations in a grid-based computing environment. The client node grid-enabled software component can be further configured to receive ad hoc questions from a client application and provide responses to the ad hoc questions by providing the results assembled by the control node grid-enabled software component to the client application. The grid-enabled software component at the control node can be configured to assemble the results by aggregating and concatenating the results of the analytical calculations being performed with the processors of the worker nodes.

In accordance with the teachings provided herein, systems and methods are provided in a grid computing system for performing analytical calculations on data stored in a distributed file system. A method involves providing a plurality of grid computing nodes including a control node and a plurality of worker nodes, the control and worker nodes comprising a processor for executing file management software (FMS) and for executing a grid-enabled software component (GESC), the control and worker nodes further comprising local storage media accessible to both the FMS and the GESC for storing data in data blocks; invoking the FMS at the control node to provide block locations for a plurality of the data blocks; instructing the grid-enabled software components at the plurality of worker nodes to retrieve locally stored data, perform an analytical calculation on the retrieved data, and send results of the analytical calculation to the grid-enabled software component at the control node; and assembling the results of the analytical calculations performed by the grid-enabled software components at the plurality of worker nodes.

These aspects and other embodiments may include one or more of the following features. The method can involve retrieving, with the grid-enabled software component at the worker nodes, locally stored data by memory mapping the local storage media. The method can involve storing, using the grid-enabled software components at the worker nodes, the results from the analytical calculations in their local storage media. The method can include receiving, via a network, the results of the analytical calculations from the worker node grid-enabled software components at the control node. The method can also include transmitting the results of the analytical calculations of the worker node grid-enabled software components using a Message Passing Interface (MPI) over the network. The method can include storing the results assembled by the control node grid-enabled software component in a distributed file system. The method can involve transmitting the results assembled by the control node grid-enabled software component to a grid-enabled software component at a client node. The method can also include determining whether one of the worker nodes experiences a failure; upon the determination that one of the worker nodes experiences the failure, instructing the grid-enabled software component at one of the other worker nodes to retrieve a portion of the data previously retrieved by the grid-enabled software component at the node that was determined to have experienced the failure and perform an analytical calculation on the retrieved data portion; receiving the results of the analytical calculation on the retrieved data portion; and assembling the results of the analytical calculation on the retrieved data portion and the results of the analytical calculations performed by other worker nodes. The method can also involve providing a grid-enabled software component at a client node; and invoking, with the client node grid-enabled software component, the grid-enabled software component at the control node to perform the analytical calculations in a grid-based computing environment. The method can include receiving, with the client node grid-enabled software component, ad hoc questions from a client application; and providing responses to the ad hoc questions by providing the results assembled by the control node grid-enabled software component to the client application. The method can involve assembling, where the assembling can involve aggregating and concatenating the results of the analytical calculations performed with the processors at the worker nodes.

In accordance with the teachings provided herein, a computer-program product for performing analytical calculations on data stored in a distributed system having a plurality of grid computing nodes including a control node and a plurality of worker nodes, the control and worker nodes comprising a processor for executing file management software (FMS) and for executing a grid-enabled software component (GESC), the control and worker nodes further comprising local storage media accessible to both the FMS and the GESC for storing data in data blocks, the computer-program product tangibly embodied in a machine-readable non-transitory storage medium and including instructions configured to cause a data processing apparatus to: invoke the FMS at the control node to provide block locations for a plurality of the data blocks; instruct the grid-enabled software components at the plurality of worker nodes to retrieve locally stored data, perform an analytical calculation on the retrieved data, and to send results of the analytical calculations to the grid-enabled software component at the control node; and assemble the results of the analytical calculations performed by the grid-enabled software components at the plurality of worker nodes.

These aspects and other embodiments may include one or more of the following features. The computer-program product can include instructions configured to cause a data processing apparatus to retrieve, with the grid-enabled software component at the worker nodes, locally stored data by memory mapping the local storage media. The computer-program product can include instructions configured to cause a data processing apparatus to store, using the grid-enabled software components at the worker nodes, the results from the analytical calculations in their local storage media. The computer-program product can include instructions configured to cause a data processing apparatus to receive, via a network, the results of the analytical calculations from the worker node grid-enabled software components at the control node. The computer-program product can include instructions configured to cause a data processing apparatus to transmit the results of the analytical calculations of the worker node grid-enabled software components, using a Message Passing Interface (MPI), over the network. The computer-program product can include instructions configured to cause a data processing apparatus to store the results assembled by the control node grid-enabled software component in a distributed file system. The computer-program product can include instructions configured to cause a data processing apparatus to transmit the results assembled by the control node grid-enabled software component to a grid-enabled software component at a client node. The computer-program product can include instructions configured to cause a data processing apparatus to: determine whether one of the worker nodes experiences a failure; upon the determination that one of the worker nodes experiences the failure, instruct the grid-enabled software component at one of the other worker nodes to retrieve a portion of the data previously retrieved by the grid-enabled software component at the node that was determined to have experienced the failure and perform an analytical calculation on the retrieved data portion; receive the results of the analytical calculation on the retrieved data portion; and assemble the results of the analytical calculation on the retrieved data portion and the results of the analytical calculations performed by other worker nodes. The computer-program product can include instructions configured to cause a data processing apparatus to: access a grid-enabled software component at a client node; and invoke, with the client node grid-enabled software component, the grid-enabled software component at the control node to perform the analytical calculations in a grid-based computing environment. The computer-program product can include instructions configured to cause a data processing apparatus to: receive, with a client node grid-enabled software component, ad hoc questions from a client application; and provide responses to the ad hoc questions by providing the results assembled by the control node grid-enabled software component to the client application. The computer-program product can include instructions configured to cause a data processing apparatus to assemble comprises instruction configured to cause a data processing apparatus to aggregate and concatenate the results of the analytical calculations performed with the processors at the worker nodes.

Other features and aspects are apparent from the description, drawings and the claims.

### BRIEF DESCRIPTION OF THE DRAWINGS

FIG. 1 is a block diagram depicting an environment wherein users can interact with a computing environment.

FIG. 2 is a block diagram depicting a computing environment containing a grid-based computing system and a file system.

FIG. 3 is a block diagram depicting hardware and software components of a grid-based computing system.

FIG. 4 is a block diagram depicting hardware and software components of a distributed file system.

FIG. 5 is a block diagram depicting hardware and software components of a grid-based computing system co-located with a distributed file system.

FIGS. 6-10 are process flow diagrams depicting a process flow of a grid-based computing system for analyzing data in a grid-based environment.

FIGS. 11-15 are process flow diagrams depicting a process flow of software components for performing data analysis in a grid-based computing environment.

FIG. 16 is a block diagram block diagram depicting example hardware for a standalone computer architecture.

### DETAILED DESCRIPTION

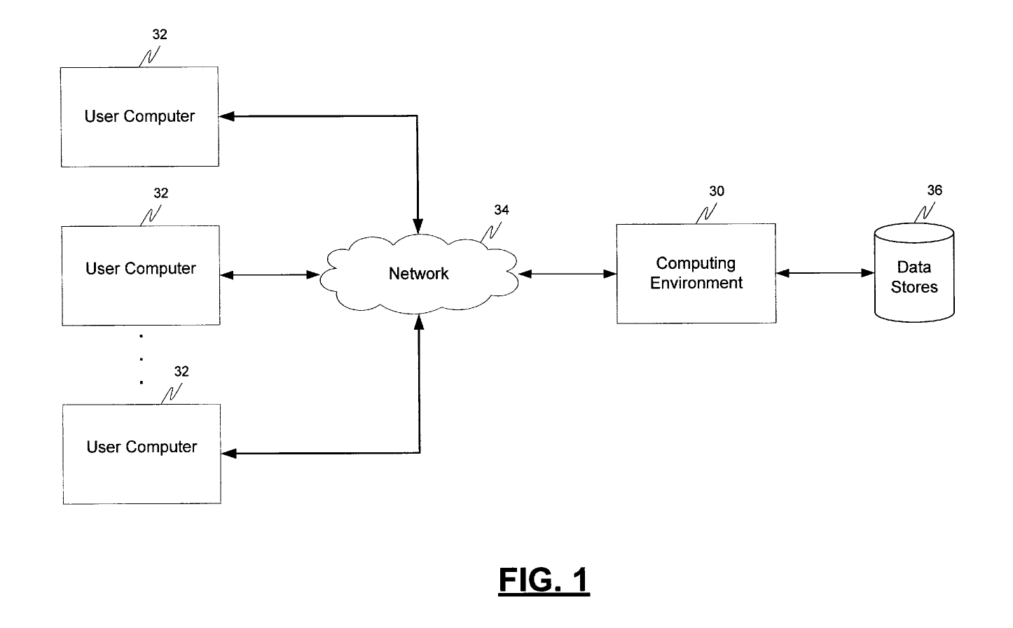

FIG. 1 depicts at 30 a computing environment for processing large amounts of data for many different types of applications, such as for scientific, technical or business applications that require a great number of computer processing cycles. User computers 32 can interact with the computing environment 30 through a number of ways, such as over a network 34.

One or more data stores 36 are used to store the data to be processed by the computing environment 30 as well as any intermediate or final data generated by the computing system in non-volatile memory. However in certain embodiments, the configuration of the computing environment 30 allows its operations to be performed such that intermediate and final data results can be stored solely in volatile memory (e.g., RAM), without a requirement that intermediate or final data results be stored to non-volatile types of memory (e.g., disk).

This can be useful in certain situations, such as when the computing environment 30 receives ad hoc queries from a user and when responses, which are generated by processing large amounts of data, need to be generated on-the-fly. In this non-limiting situation, the computing environment 30 is configured to retain the processed information within memory so that responses can be generated for the user at different levels of detail as well as allow a user to interactively query against this information.

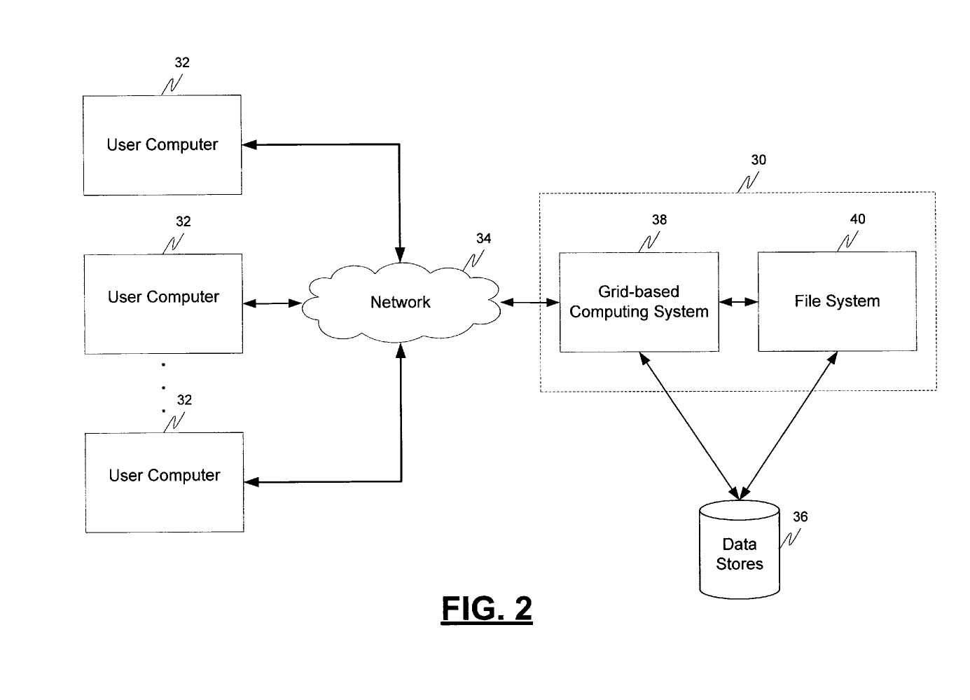

FIG. 2 illustrates an example computing environment 30. The example computing environment 30 includes a grid-based computing system 38 for processing large amounts of data and a file management system 40 for managing, storing, and retrieving large amounts of data that are distributed to and stored in the multiple data stores 36 that reside at different locations within a distributed file system. As the hashed lines in FIG. 2 are intended to indicate, the compute nodes in the grid-based computing system 38 and the file management system 40 share the same processor hardware.

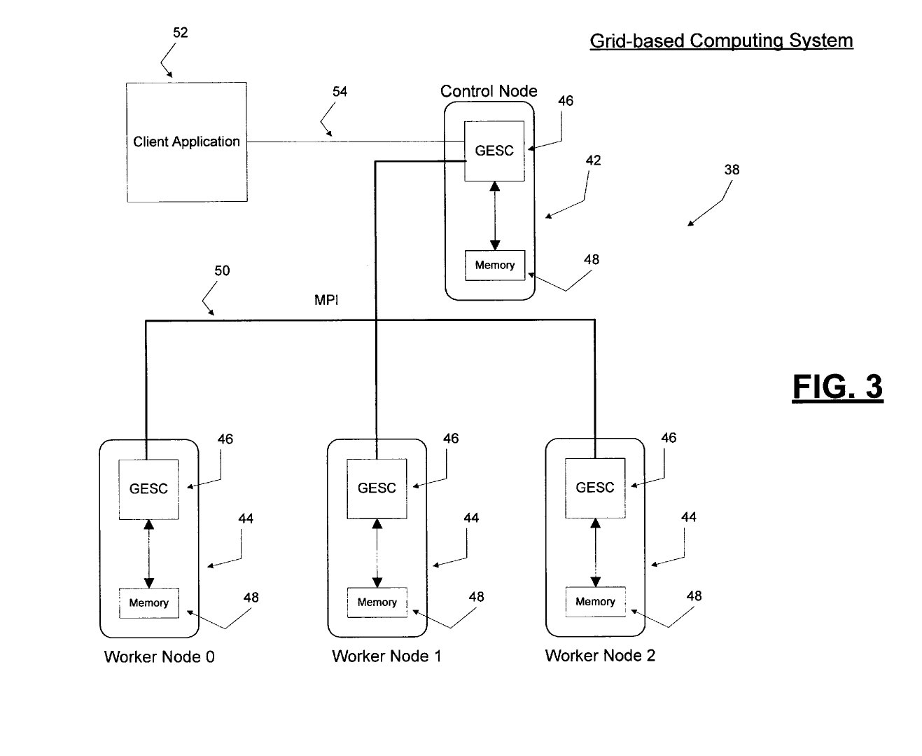

FIG. 3 illustrates hardware and software components for a grid-based computing system 38. The grid-based computing system 38 includes a number of data processing nodes 42, 44 comprising multi-core data processors. One of the nodes is designated a control data processing node 42 and a plurality of the nodes are designated as worker data processing nodes 44. Each data processing node 42, 44 includes a grid-enabled software component (GESC) 46 that executes on the data processor associated with that node and interfaces with buffer memory 48 also associated with that node. Examples of a GESC include High Performance Analytics and Visual Analytics provided by the SAS Institute.

The GESC 46 at the various nodes 42, 44 are connected via a network 50 and can communicate with each other using a predetermined communication protocol such as the Message Passing Interface (MPI). Each GESC 46 can engage in point-to-point communication with the GESC at another node or in collective communication with multiple GESCs via the network 50. The GESC 46 at each node in this example contains identical software instructions and each data processing node is capable of operating as either a control node 42 or a worker node 44. The GESC at the control node 42 can communicate with a client application 52 over a communication path 54 to receive ad hoc queries from a user and to respond to those ad hoc queries after processing large amounts of data.

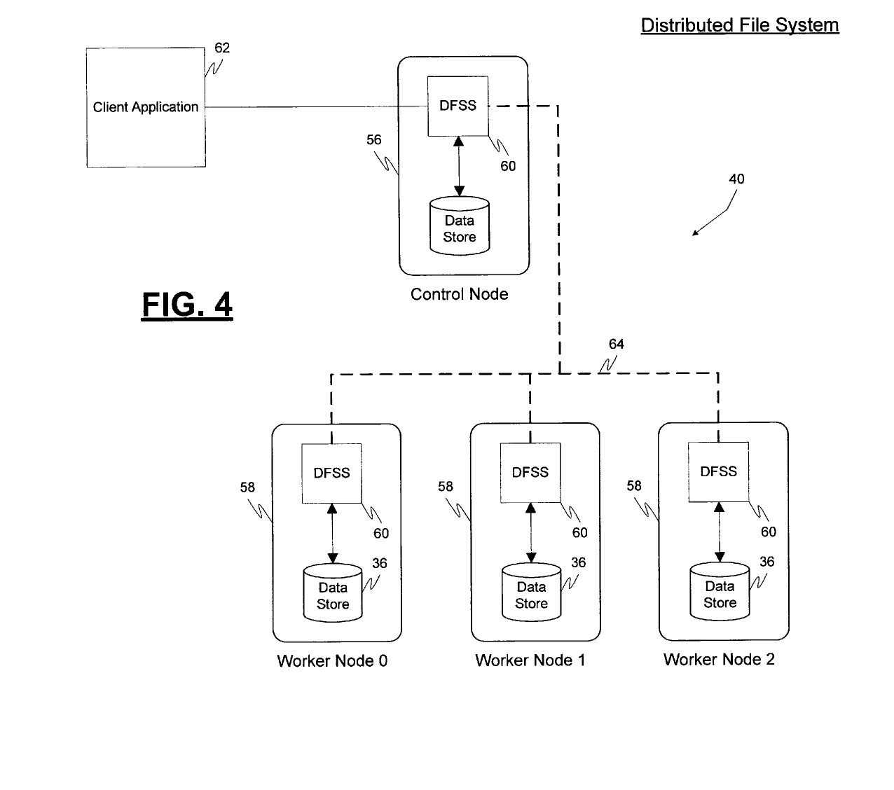

FIG. 4 illustrates hardware and software components for a distributed file system 40. The distributed file system 40 includes distributed file system software (DFSS) 60 that executes on a file system server at a control node 56 and on a file system server at each of a plurality of worker nodes 58. The open source Hadoop distributed file system is an example of a type of distributed file system. Each node 56, 58 includes a file server and one or more data stores 36 that are attached to the file server. The file server executes the distributed file system software (DFSS) 60, which controls the creation, maintenance, and the use of a file system (i.e., a data structure) that organizes data stored in the data stores 36. The DFSS at the control node 56 of the distributed file system 40 communicates with a client application 62 to accept requests for data and to instruct the file system to transfer the appropriate data. The DFSS 60 at each file system node can communicate with each other via a network 64.

With the distributed file system, collections of data are distributed across multiple physical locations. In this example, each file system node 56, 58 in the distributed system stores in its associated data store 36 a portion of the total data managed by the DFSS. One process typically employed by the DFSS to protect against data loss is replication. Replication typically involves providing one or more backup copies of the data stored on one node on one or more other nodes. When replication is employed, if one node fails, then the data from the failed node can be recovered from a replicated copy residing at another node.

As illustrated in FIG. 4, each file system node 56, 58 in the distributed file system has distinct data stores 36, such as disks or other memory devices, as well as distinct main memory. In distributed file systems where the data are kept current in all locations, distributed query processing can take place.

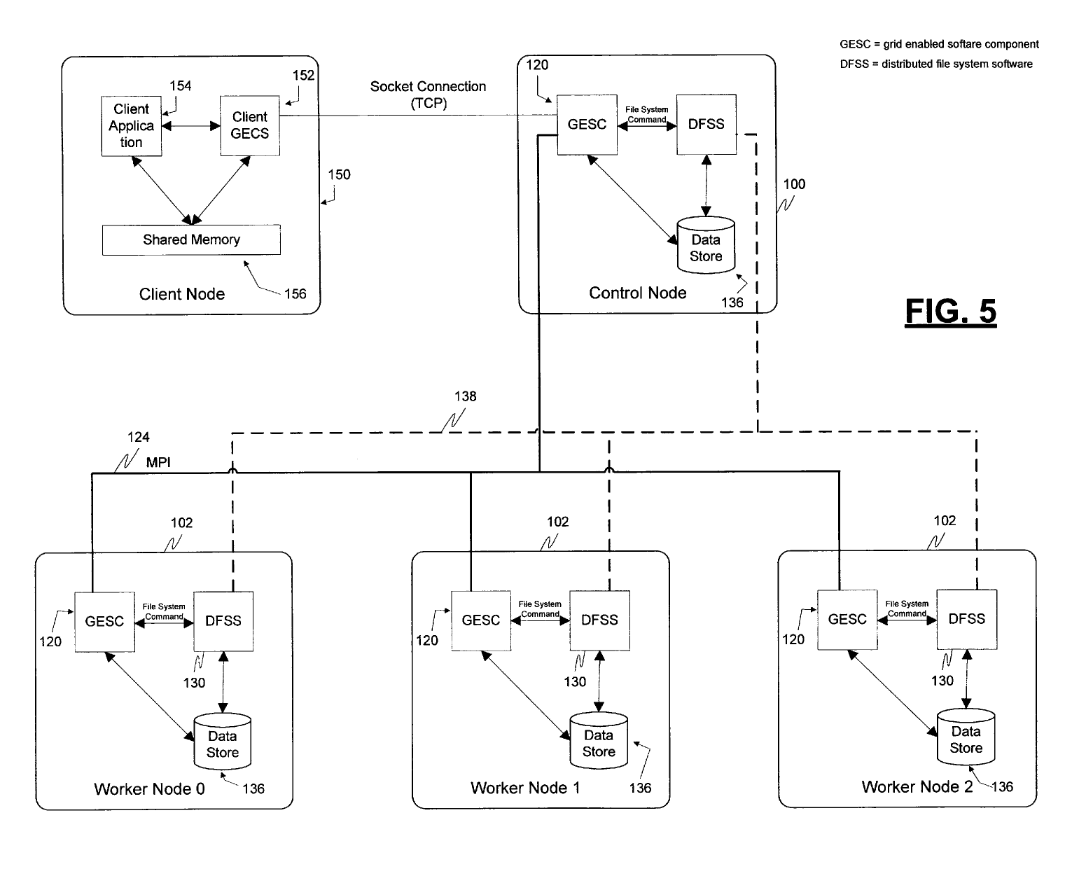

FIG. 5 depicts a grid-based computing system that is co-located with a distributed file system. In this embodiment, each of a number of data processor nodes 100, 102 includes a data processor that can be shared by a distributed file system and a grid-based computing system. Each data processing node includes a grid-enabled software component (GESC) 120, which is connected to a data store 136, and distributed file system software (DFSS) 130, which is also connected to the data store 136. Each node can execute both the GESC 120 and the DFSS 130. The execution of the GESC 120 at various nodes allows for the operation of a grid-based computing environment for performing complex data analysis. Similarly, the execution of the DFSS 130 at the nodes allows for the operation of a distributed file system for storing data to be used in the data analysis.

Similar to the distributed file system illustrated in FIG. 4, the DFSS 130 at each node 100, 102 can communicate with DFSS at other nodes via a network 138, and similar to the grid-based computing system illustrated in FIG. 3, the GESC 120 at the various nodes 100, 102 are connected via a network 124 and can communicate with each other using a predetermined communication protocol such as the Message Passing Interface (MPI). Each GESC 120 can engage in point-to-point communication with the GESC at another node or in collective communication with multiple GESCs via the network 124. In the illustrated embodiment, the control node 100 has the same hardware configuration as the worker nodes 102.

In this example, the GESC 120 at each node contains identical software instructions. The GESC however has multiple execution modes. Because of the multiple execution modes each data processing node 100, 102 is capable of operating as a control node 100 or a worker node 102.

File system commands can be executed between the GESC and the DFSS 130 at each node to transfer information regarding the data stored in the data stores 136 that are managed by the DFSS 130. For example, files system commands can be invoked by the GESC to find the location of information stored in the data store. In response to the file system command, the DFFS can return the block location of a requested data file. The GESC can then directly access the requested data file from the data store. In one example, the GESC memory maps the data store to allow it to directly access data files for the performance of analytic calculations. Additionally, the GESC can store information directly in the data store and through the use of file system commands instruct the DFSS on the block locations at which the information has been stored.

FIG. 5 also illustrates an embodiment wherein a client application node 150 is communicatively coupled to the control node 100 of a grid-based computing system that is co-located with a distributed file system. The client application node 150 includes a client GESC 152 and a client application 154 that execute on a shared data processor and memory 156. The illustrated client application 154 may request that data analysis be performed by the grid-based computing system. The illustrated client GESC 152 interfaces with the client application 154 to receive the request from the client application for data analysis and to provide the results of the data analysis to the client application.

In this example, the client GESC 152 contains software instructions that are identical to the software instructions of the GESC 120 at the control and worker nodes. The GESC at each of these nodes in this embodiment have an additional mode of operation, a client mode. In the client mode, the GESC 152 can communicate with the GESC 120 at the control node, for example over a socket connection such as a TCP connection, to instruct the grid-based computing environment to perform data analysis and to receive the results of the data analysis for provision to the requesting client application.

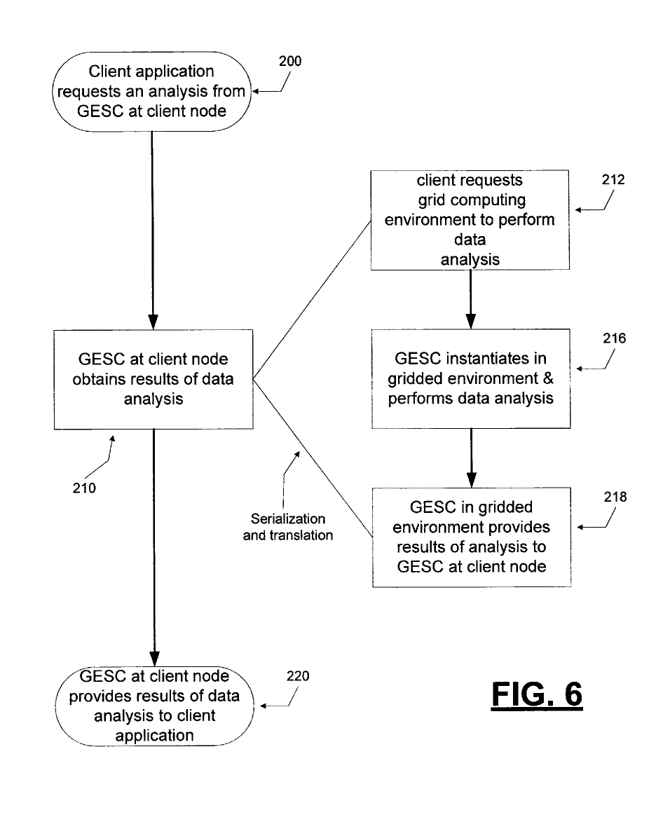

FIG. 6 illustrates an example process for performing data analysis. The GESC at the client node communicates with a client application at the client node to receive ad hoc queries from a user and to respond to those ad hoc queries after large amounts of data have been processed. As illustrated at step 200, the client application presents an ad hoc query to the client GESC that requires that an analysis of data be performed. The ad hoc query can contain instructions on the type of data analysis to be performed and whether the analysis should be performed using the grid-based computing environment. At step 210, the client GESC initiates the requested data analysis and obtains the results of the data analysis. At step 220, the client GESC provides the results of the analysis to the client application.

In the illustrated embodiment, initiating the requested data analysis and obtaining the results (step 210) requires the performance of a number of steps. As shown, at step 212, the client GESC determines that the ad hoc query requires the use of the grid-based computing environment to perform the data analysis. Next, the client GESC at step 216 causes the GESC to be instantiated in the grid-based computing environment and causes the grid-based computing system to perform the data analysis. This determination may also involve determining the configuration of the grid-based computing environment. For example, this determination may include the number of worker nodes and the number of threads per worker node to be employed when performing the data analysis. At step 218, the GESC in the grid-based computing environment provides the results of the analysis to the client GESC.

The provision of the results from the grid-based computing environment to the client node may require translation of data because of differences between the operating system in the grid-based computing environment and the operating system that executes on the client node. For example, the data processor that executes the control node GESC may have a 64-bit Linux operating system, and the data processor that executes the client GESC may have a 32-bit operating system, such as a 32-bit Windows PC operating system. The representation of wide-char characters is different in the two operating systems and the characters in the Linux format must be translated into the proper representation on the Windows client.

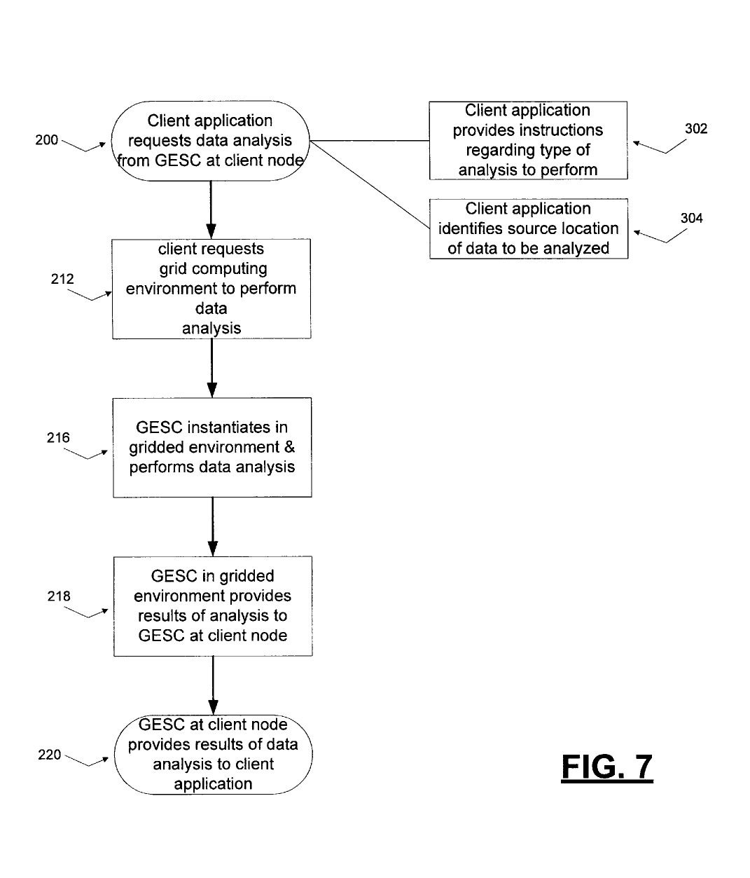

In the embodiment illustrated at FIG. 7, example elements are provided for illustrating components of an ad hoc query from a client application to the client GESC. Depicted at 302, the client application provides instructions on the type of data analysis to perform. Depicted at 304, the client application identifies the source location of data to be used in the data analysis. The data to be used in the data analysis in this example is stored in the distributed file system that is co-located with the grid-based computing environment.

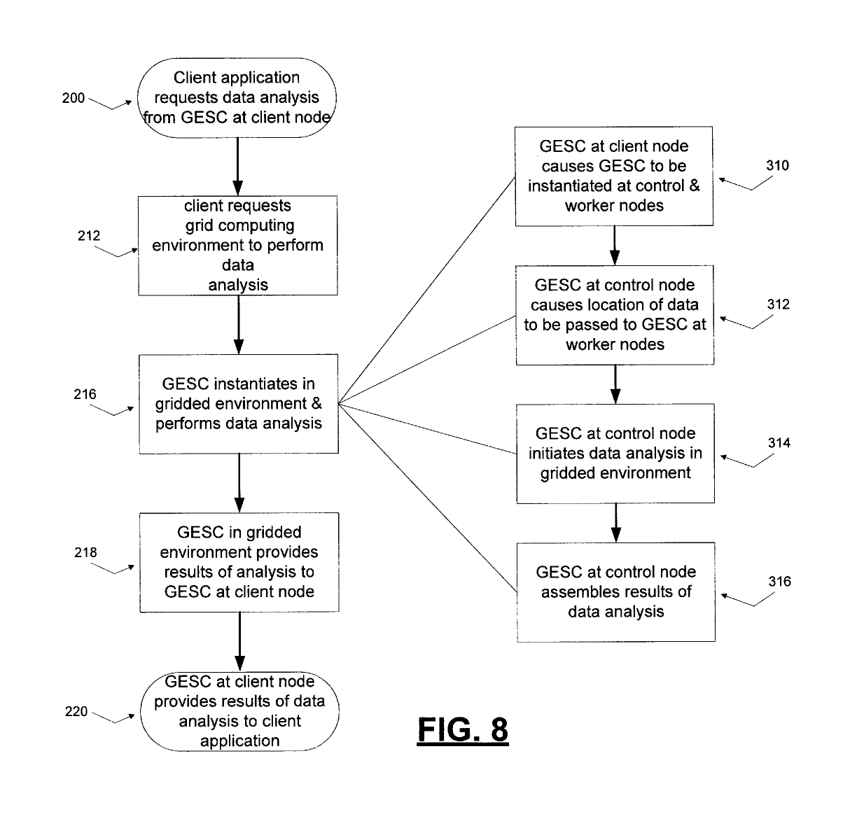

In the embodiment illustrated at FIG. 8, example steps are provided for instantiating the GESC in the grid-based computing environment to perform the requested data analysis. At step 310 the client node GESC causes the GESC to be instantiated at the control node and a plurality of worker nodes. At step 312, the control node GESC causes the location of data to be used in the analysis to be passed to the GESC at the worker nodes. At step 314, the GESC at the control node initiates the data analysis in the grid-based computing environment. Finally, at step 316, the GESC at the control node assembles the results from analysis performed by the GESC at the various worker nodes.

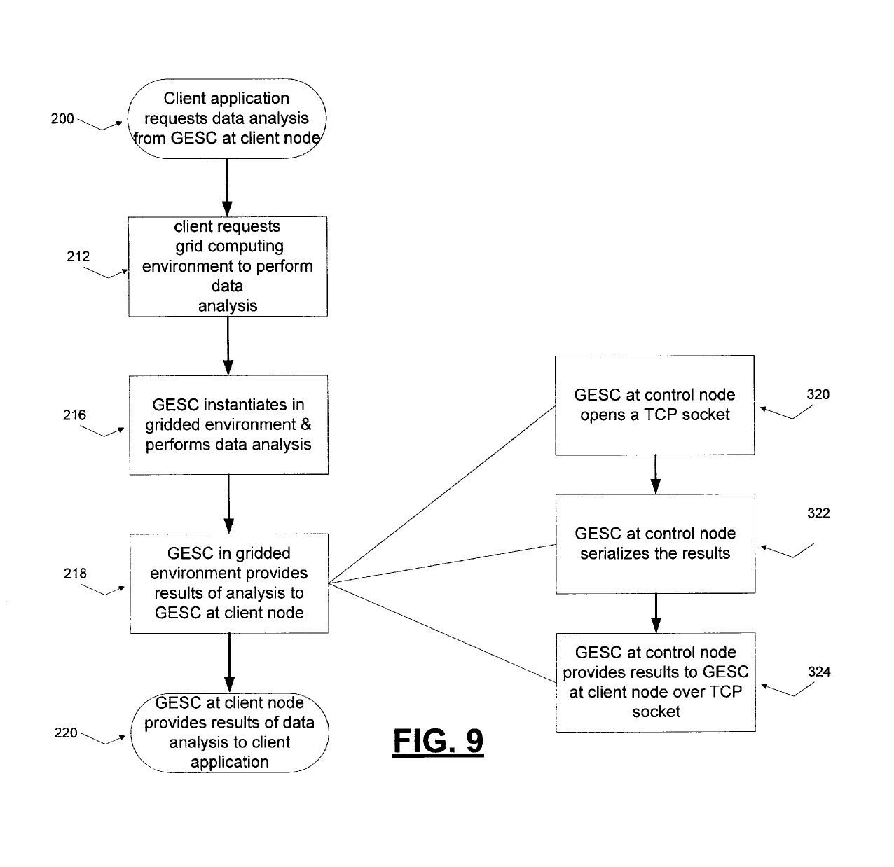

In the embodiment depicted at FIG. 9, example steps are provided to illustrate a method for use by the control node GESC in providing the results of the data analysis to the client node GESC. At step 320 the control node GESC opens a TCP socket connection. At step 322, the control node GESC serializes the results of the data analysis. At step 324, the control node provides the serialized results of the data analysis to the client node GESC over the TCP socket.

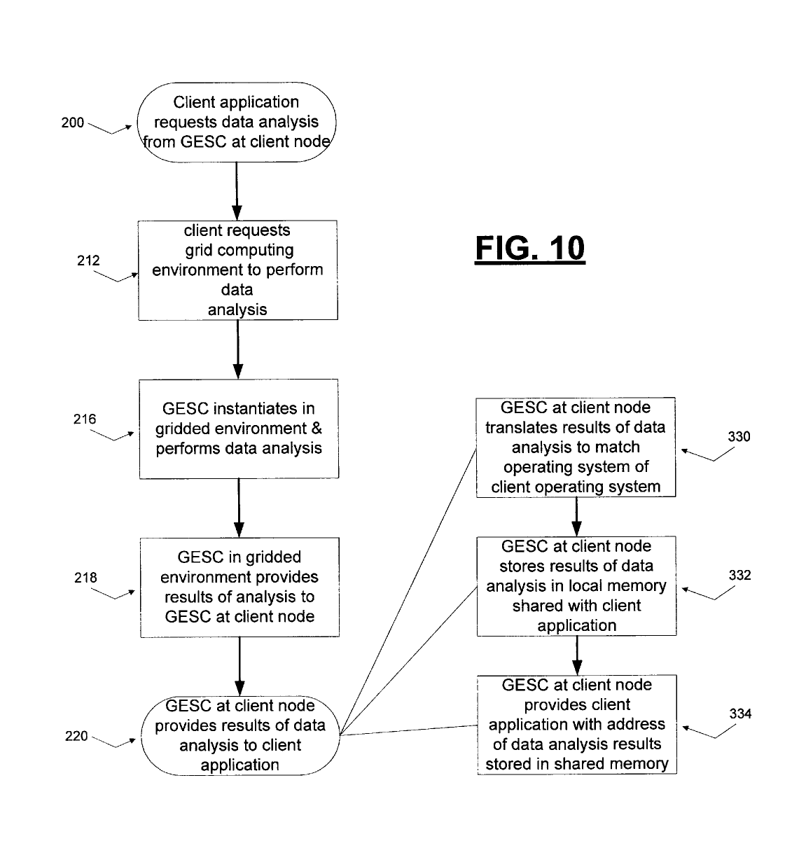

In the embodiment depicted at FIG. 10, example steps are provided for use by the client node GESC in providing the results of the data analysis to the requesting client application. At step 330, the client node GESC translates the serialized data analysis results received from the control node GESC into a format that can be recognized by the operating system of the client application. At step 332, the client node GESC stores the translated data analysis results in local memory shared between the client node GESC and the client application. Finally, at step 334, the client node GESC provides the client application with the address, in the shared memory, of the translated data analysis results.

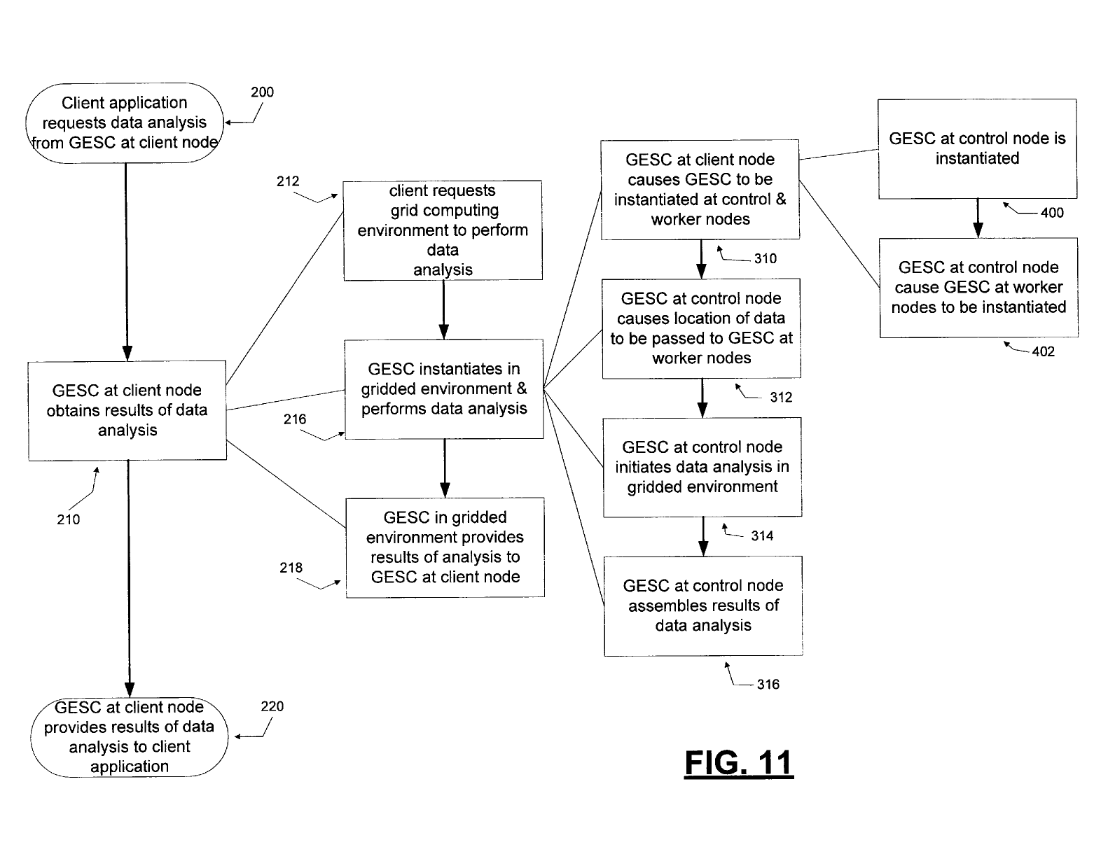

In the embodiment depicted at FIG. 11, example steps are provided to illustrate a method for the instantiation of the GESC in the grid-based computing environment. At step 400, the GESC at the control node is instantiated. At step 402, based on the number of potential worker nodes available and the number of worker nodes desired to perform the data analysis, the control node GESC causes the GESC at worker nodes to be instantiated.

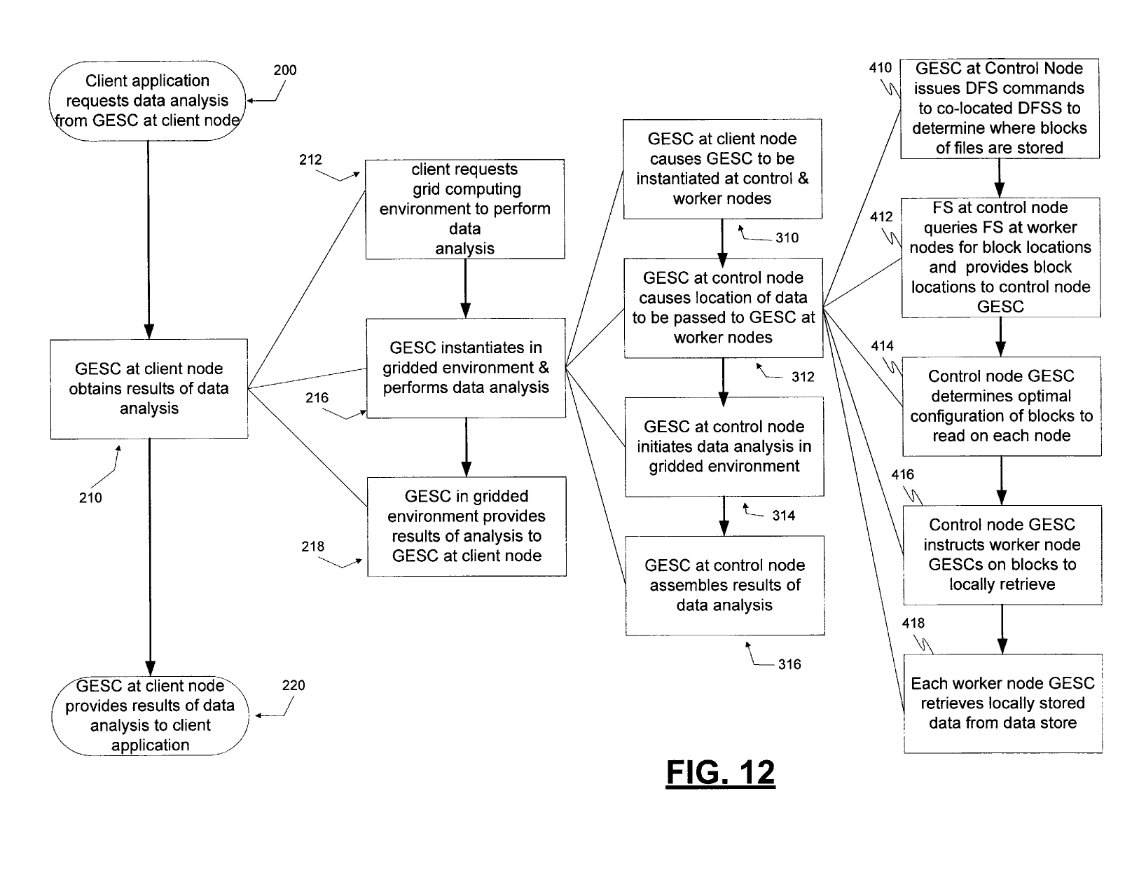

Depicted in FIG. 12 are example steps illustrating a method for the control node GESC to use to cause the data that is to be used in the analysis to be provided to the worker node GESCs. At step 410 the control node GESC issues a distributed file system (DFS) command to the DFSS at the control node to determine where particular blocks of files are stored. At step 412 the control node DFSS queries the DFFS at the worker nodes for the requested block locations and provides the block locations to the control node GESC. At step 414, using the block locations provided by the DFFS, the control node GESC determines the optimal configuration of blocks to read at the various nodes to perform the requested data calculations. At step 416, the control node GESC instructs the worker node GESCs on which data blocks to read and perform data calculations on. At step 418, the worker node GESCs retrieve the locally stored data directly from the data store. In this example, each worker node GESC retrieves a portion of the overall set of data to be used in the data analysis. Alternatively, each or some of the worker node GESCs could retrieve the complete set of data to be used in the analysis.

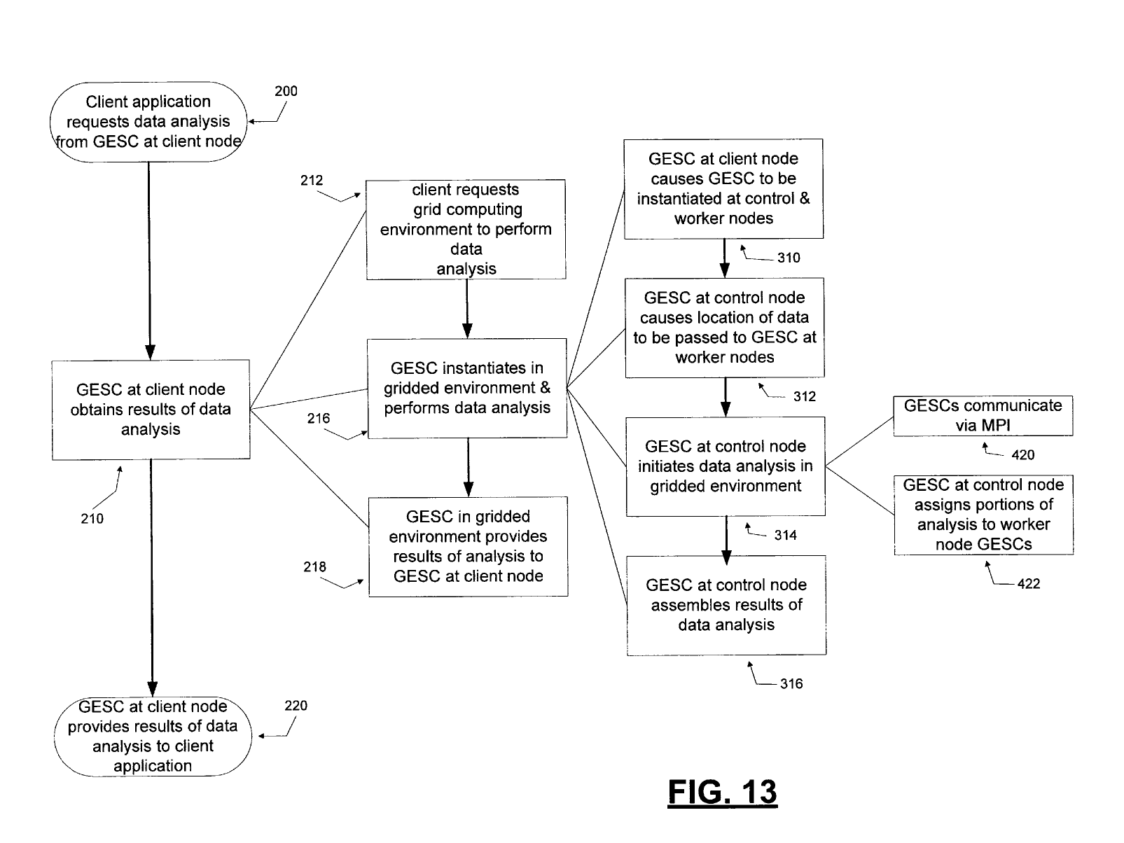

Illustrated at FIG. 13 are example steps that may be implemented when initiating data analysis in the grid-based computing environment. At step 420, the control node GESC communicates with the worker node GESCs over a communication network using the Messaging Passing Interface (MPI). At step 422, the control node GESC assigns a portion of the analysis to worker node GESCs. In this example, all of the worker node GESCs perform the same analytical calculations, but on different portions of the overall set of data to be used in the analysis. Alternatively, the control node GESC could instruct a plurality of worker node GESCs to perform different analytical steps.

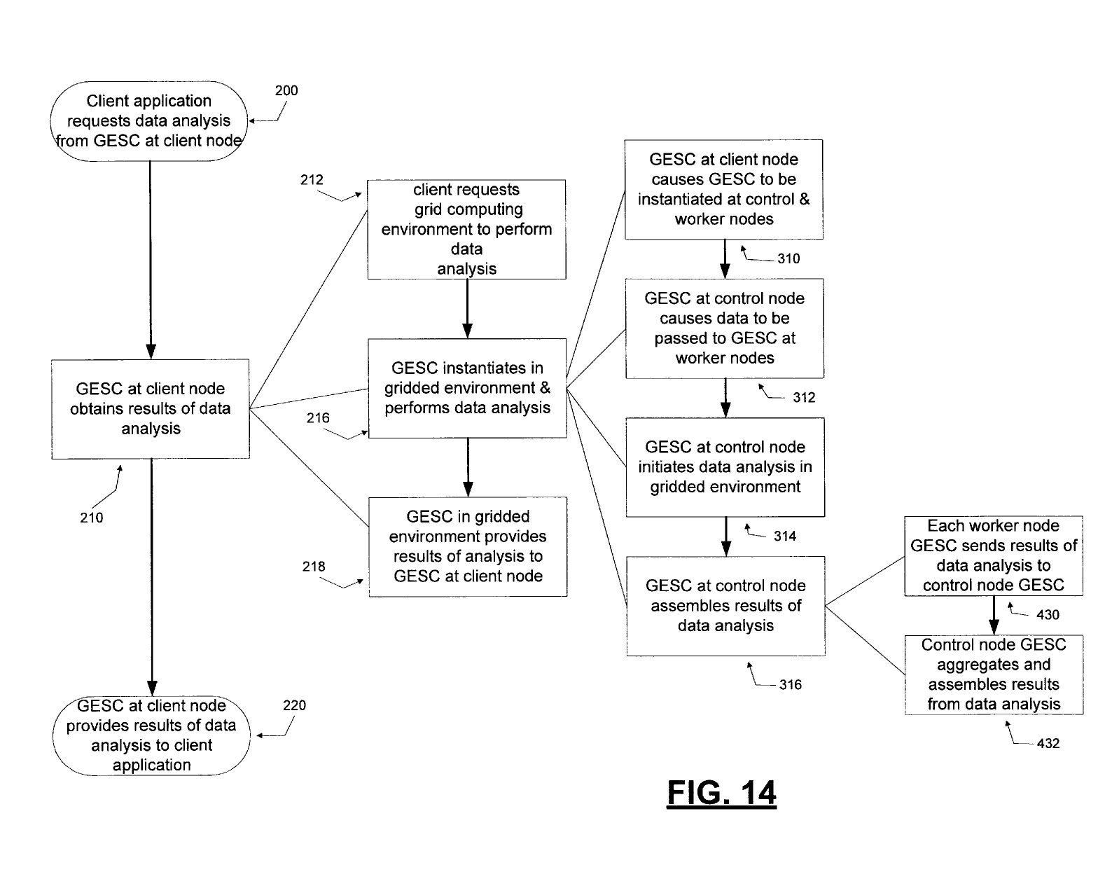

Illustrated at FIG. 14 are example steps for assembling the data analysis results at the control node. At step 430, the worker-node GESCs send the results from their analytical calculations to the control node GESC. One way the results generated by the worker-node GESCs can be transmitted to the control node GESC is via MPI. Another way the results could be transmitted is by the worker node GESCs storing their data analysis results in the distributed file system and providing the location of the results in the distributed file system to the control node GESC via MPI. At step 432, the control node GESC aggregates and assembles the results from the analytical calculations performed by the worker node GESCs. The results could be stored in local memory or in the distributed file system. The control node GESC may also perform at 432 additional mathematical operations (e.g., descriptive statistical calculations) on the aggregated data before final assembly of the results.

The GESC can directly produce file blocks on the data store without having to engage the DFSS. The GESC can direct which nodes receive the original copy of the data, thereby achieving a homogenous distribution of data. The GESC can write the file blocks in a specific format. The specific format can be a highly efficient binary format for high-performance computing in distributed environments, where the blocks contain their own metadata (e.g., variable names and labels, formats, internationalization encoding, etc.). This specific format can prevent breaking rows of data across blocks which is common for regular files in other distributed file systems and which requires extra management of partial rows when data are retrieved in those distributed file systems. Once the GESC writes blocks, it informs the file system which collection of blocks make up a file.

In case of a node failure while calculations are underway, the control node GESC can reinitiate data analysis in the grid-based computing environment without having to redistribute the data to be used in the data analysis. Because the various worker nodes GESCs are co-located at nodes with DFSS, the distributed file system protection mechanisms can protect against data loss during a node failure. The local DFSS has access to a replicate copy of the data to be used in the data analysis and provides access to the data via the data stores to the various worker node GESCs. When recalculations are necessary due to a node failure, the control node GESC can reassign the portion of the analysis previously assigned to the failed node to the GESC at one or more of the remaining worker nodes (or a new worker node). This may involve instructing one or more worker node GESCs to perform their analytical calculation on additional data.

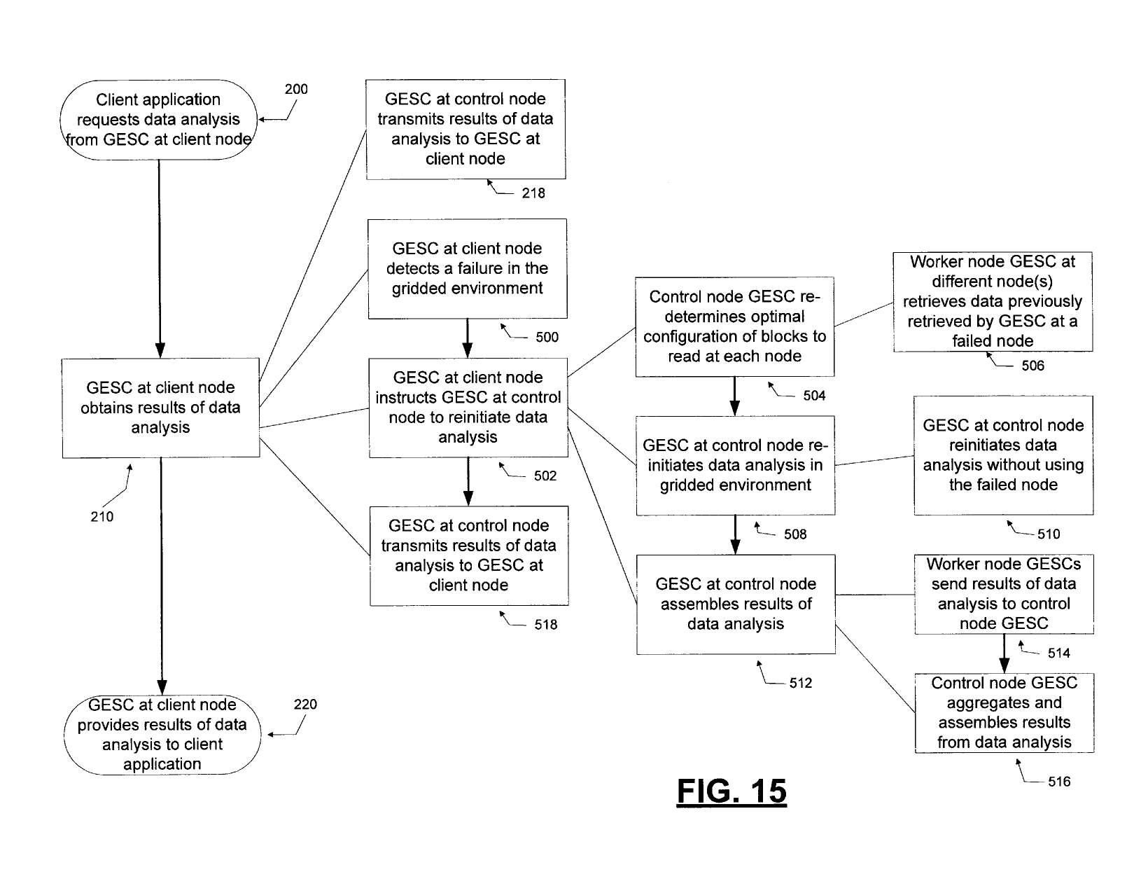

Depicted at FIG. 15 are example steps for recovery from a node failure. The client node GESC detects a failure in the grid-based computing environment (step 500). At step 502, the client node GESC instructs the control node GESC to reinitiate the data analysis. At step 504, the control node GESC re-determines the optimal configuration of blocks to read at each node. If there is a failed node, the DFSS causes the data that resided on the failed node to be replaced by its replicate copy that resides on one or more non-failed nodes. The data previously retrieved by the GESC at the failed node is retrieved by the GESC at a different node (step 506). This may result in the GESC at one of the nodes retrieving the data originally provided to it plus the data originally provided to the GESC at the failed node. Alternatively, it may result in the GESC at a new node retrieving the data originally provided to the GESC at the failed node. At step 508, the GESC at the control node reinitiates data analysis. This involves, at step 510, the control node GESC reinitiating the data analysis without the failed node. At step 514, the worker node GESCs send the results from their analytical calculations to the control node GESC. At step 516, the control node GESC aggregates and reassembles the results from the data analysis. At step 518, the control node GESC transmits the results of the data analysis to the client node GESC.

Referring back to FIG. 2, a multi-user environment involving the grid-based computing environment is depicted. In such an environment, each user 32 will receive its own client GESC to handle its queries and to communicate with a selected control node GESC.

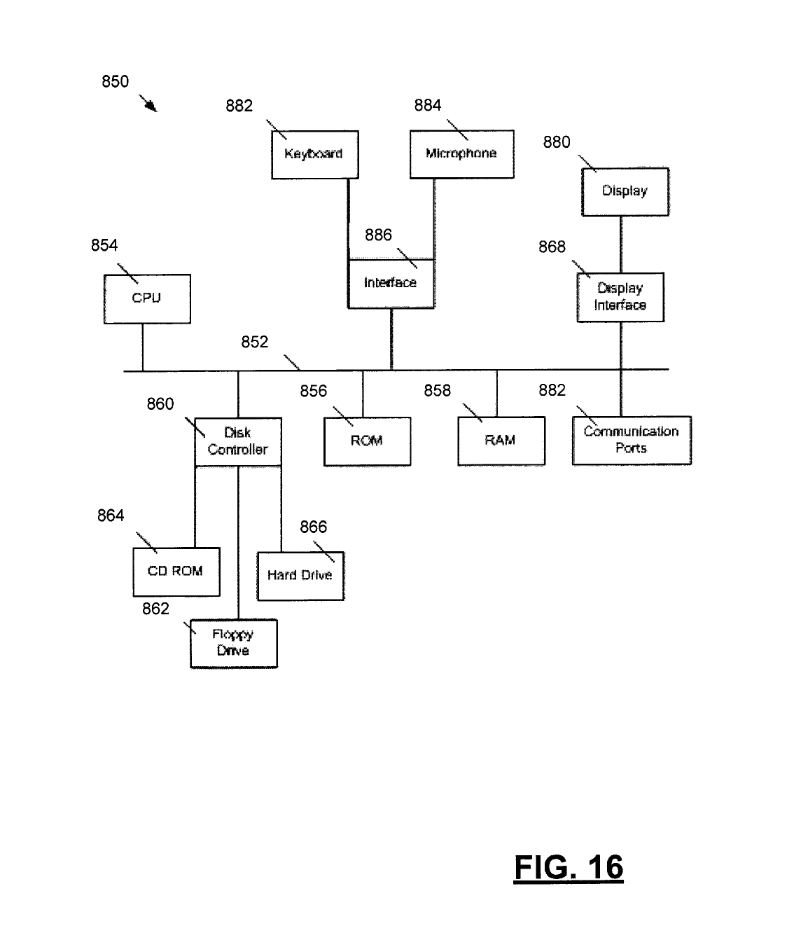

FIG. 16 shows a block diagram of an example of hardware for a standalone computer architecture 850, such as the architecture depicted in FIG. 2 that may be used to contain and/or implement the program instructions of system embodiments of the present invention. A bus 852 may connect the other illustrated components of the hardware. A processing system 854 labeled CPU (central processing unit) (e.g., one or more computer processors), may perform calculations and logic operations required to execute a program. A processor-readable storage medium, such as read only memory (ROM) 856 and random access memory (RAM) 858, may be in communication with the processing system 854 and may contain one or more programming instructions for performing an index join operation. Optionally, program instructions may be stored on a computer readable storage medium such as a magnetic disk, optical disk, recordable memory device, flash memory, or other physical storage medium. Computer instructions may also be communicated via a communications signal, or a modulated carrier wave.

A disk controller 860 interfaces one or more optional disk drives to the system bus 852. These disk drives may be external or internal floppy disk drives such as 862, external or internal CD-ROM, CD-R, CD-RW or DVD drives such as 864, or external or internal hard drives 866. As indicated previously, these various disk drives and disk controllers are optional devices.

Each of the element managers, real-time data buffer, conveyors, file input processor, database index shared access memory loader, reference data buffer and data managers may include a software application stored in one or more of the disk drives connected to the disk controller 860, the ROM 856 and/or the RAM 858. Preferably, the processor 854 may access each component as required.

A display interface 868 may permit information from the bus 852 to be displayed on a display 870 in audio, graphic, or alphanumeric format. Communication with external devices may optionally occur using various communication ports 872.

In addition to the standard computer-type components, the hardware may also include data input devices, such as a keyboard 873, or other input device 874, such as a microphone, remote control, pointer, mouse and/or joystick.

This written description uses examples to disclose the invention, including the best mode, and also to enable a person skilled in the art to make and use the invention. The patentable scope of the invention may include other examples. Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It should be understood that the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

It is claimed:

1. A grid computing system for performing analytical calculations on data stored in a distributed file system, the grid computing system comprising:
a plurality of grid computing nodes including a control node and a plurality of worker nodes, the control and worker nodes comprising:
a processor configured to execute distributed file system software and a grid-enabled software component; and
local storage media accessible to distributed file system software for storing data in data blocks, wherein the grid-enabled software component is configured to perform analytical calculations on the data; and
the grid-enabled software component at the control node being configured to:
invoke the distributed file system software at the control node to provide block locations for a plurality of the data blocks;
determine a configuration of data blocks to read at the plurality of worker nodes;
instruct the grid-enabled software components at the plurality of worker nodes to retrieve locally stored data, perform an analytical calculation on the retrieved data, and send results of the analytical calculation on the retrieved data to the grid-enabled software component at the control node; and
assemble the results of the analytical calculations performed by the grid-enabled software components at the plurality of worker nodes.

2. The system according to claim 1, wherein the grid-enabled software components at the plurality of worker nodes are configured to retrieve locally stored data by memory mapping the local storage media.

3. The system according to claim 1, wherein the grid-enabled software components at the plurality of worker nodes are configured to store the results from the analytical calculations in the respective local storage media.

4. The system according to claim 1, wherein the plurality of worker node grid-enabled software components are configured to send the results of the analytical calculations to the control node grid-enabled software component via a network.

5. The system according to claim 4, wherein a plurality of the worker node grid-enabled software components are configured to transmit their results using a Message Passing Interface (MPI) over the network.

6. The system according to claim 1, wherein the control node grid-enabled software component is configured to store the assembled results in the distributed file system.

7. The system according to claim 1, wherein the control node grid-enabled software component is configured to transmit the assembled results to a grid-enabled software component at a client node.

8. The system according to claim 1, wherein upon the determination that one of the worker nodes experienced a failure:
the grid-enabled software component at the control node is configured to instruct the grid-enabled software component at one of the other worker nodes to retrieve a portion of the data previously retrieved by the grid-enabled software component at the node that was determined to have experienced the failure;
the grid-enabled software component instructed to retrieve the previously retrieved data is configured to perform an analytical calculation on the previously retrieved data and provide the results to the grid-enabled software component at the control node; and
the grid-enabled software component at the control node is configured to assemble the results received from the grid-enabled software components at the other worker nodes.

9. The system according to claim 1, further comprising a grid-enabled software component at a client node wherein the client node grid-enabled software component is configured to invoke the grid-enabled software component at the control node to perform the analytical calculations in a grid-based computing environment.

10. The system according to claim 9 wherein the client node grid-enabled software component is further configured to receive ad hoc questions from a client application and to provide responses to the ad hoc questions by providing the results assembled by the control node grid-enabled software component to the client application.

11. The system according to claim 1, wherein the grid-enabled software component at the control node is configured to assemble the results by aggregating and concatenating the results of the analytical calculations performed with the processors of the worker nodes.

12. A method in a grid computing system for performing analytical calculations on data stored in a distributed file system, the method comprising:
providing a plurality of grid computing nodes including a control node and a plurality of worker nodes, the control and worker nodes comprising a processor for executing file management software (FMS) and for executing a grid-enabled software component (GESC), the control and worker nodes further comprising local storage media accessible to both the FMS and the GESC for storing data in data blocks;
invoking the FMS at the control node to provide block locations for a plurality of the data blocks;
instructing the grid-enabled software components at the plurality of worker nodes to retrieve locally stored data, perform an analytical calculation on the retrieved data, and send results of the analytical calculation to the grid-enabled software component at the control node; and
assembling the results of the analytical calculations performed by the grid-enabled software components at the plurality of worker nodes.

13. The method according to claim 12 further comprising retrieving, with the grid-enabled software component at the plurality of worker nodes, locally stored data by memory mapping the local storage media.

14. The method according to claim 12 further comprising storing, using the grid-enabled software components at the plurality of worker nodes, the results from the analytical calculations in their local storage media.

15. The method according to claim 12 further comprising receiving, via a network, the results of the analytical calculations from the plurality of worker node grid-enabled software components at the control node.

16. The method according to claim 15 further comprising transmitting the results of the analytical calculations of a plurality of the worker node grid-enabled software components, using a Message Passing Interface (MPI) over the network.

17. The method according to claim 12, further comprising storing the results assembled by the control node grid-enabled software component in a distributed file system.

18. The method according to claim 12, further comprising transmitting the results assembled by the control node grid-enabled software component to a grid-enabled software component at a client node.

19. The method according to claim 12, further comprising:
determining whether one of the worker nodes experiences a failure;
upon the determination that one of the worker nodes experiences the failure,
instructing the grid-enabled software component at one of the other worker nodes to retrieve a portion of the data previously retrieved by the grid-enabled software component at the node that was determined to have experienced the failure and perform an analytical calculation on the retrieved data portion;
receiving the results of the analytical calculation on the retrieved data portion; and
assembling the results of the analytical calculation on the retrieved data portion and the results of the analytical calculations performed by other worker nodes.

20. The method according to claim 12, further comprising:
providing a grid-enabled software component at a client node; and
invoking, with the client node grid-enabled software component, the grid-enabled software component at the control node to perform the analytical calculations in a grid-based computing environment.

21. The method according to claim 20, further comprising:
receiving, with the client node grid-enabled software component, ad hoc questions from a client application; and
providing responses to the ad hoc questions by providing the results assembled by the control node grid-enabled software component to the client application.

22. The method according to claim 12, wherein the assembling comprises aggregating and concatenating the results of the analytical calculations performed with the processors at the worker nodes.

23. A computer-program product for performing analytical calculations on data stored in a distributed system having a plurality of grid computing nodes including a control node and a plurality of worker nodes, the control and worker nodes comprising a processor for executing file management software (FMS) and for executing a grid-enabled software component (GESC), the control and worker nodes further comprising local storage media accessible to both the FMS and the GESC for storing data in data blocks, the computer-program product tangibly embodied in a machine-readable non-transitory storage medium and including instructions configured to cause a data processing apparatus to:
invoke the FMS at the control node to provide block locations for a plurality of the data blocks;
instruct the grid-enabled software components at the plurality of worker nodes to retrieve locally stored data, perform an analytical calculation on the retrieved data, and to send results of the analytical calculations to the grid-enabled software component at the control node; and
assemble the results of the analytical calculations performed by the grid-enabled software components at the plurality of worker nodes.

24. The computer-program product according to claim 23 further comprising instructions configured to cause a data processing apparatus to retrieve, with the grid-enabled software component at the plurality of worker nodes, locally stored data by memory mapping the local storage media.

25. The computer-program product according to claim 23 further comprising instructions configured to cause a data processing apparatus to store, using the grid-enabled software components at the plurality of worker nodes, the results from the analytical calculations in their local storage media.

26. The computer-program product according to claim 23 further comprising instructions configured to cause a data processing apparatus to receive, via a network, the results of the analytical calculations from the plurality of worker node grid-enabled software components at the control node.

27. The computer-program product according to claim 26 further comprising instructions configured to cause a data processing apparatus to transmit the results of the analytical calculations of a plurality of the worker node grid-enabled software components, using a Message Passing Interface (MPI), over the network.

28. The computer-program product according to claim 23 further comprising instructions configured to cause a data processing apparatus to store the results assembled by the control node grid-enabled software component in a distributed file system.

29. The computer-program product according to claim 23 further comprising instructions configured to cause a data processing apparatus to transmit the results assembled by the control node grid-enabled software component to a grid-enabled software component at a client node.

30. The computer-program product according to claim 23 further comprising instructions configured to cause a data processing apparatus to:
determining whether one of the worker nodes experiences a failure;
upon the determination that one of the worker nodes experiences the failure,
instruct the grid-enabled software component at one of the other worker nodes to retrieve a portion of the data previously retrieved by the grid-enabled software component at the node that was determined to have experienced the failure and perform an analytical calculation on the retrieved data portion;
receive the results of the analytical calculation on the retrieved data portion; and
assemble the results of the analytical calculation on the retrieved data portion and the results of the analytical calculations performed by other worker nodes.

31. The computer-program product according to claim 23 further comprising instructions configured to cause a data processing apparatus to:
access a grid-enabled software component at a client node; and
invoke, with the client node grid-enabled software component, the grid-enabled software component at the control node to perform the analytical calculations in a grid-based computing environment.

32. The computer-program product according to claim 23 further comprising instructions configured to cause a data processing apparatus to:
receive, with a client node grid-enabled software component, ad hoc questions from a client application; and
provide responses to the ad hoc questions by providing the results assembled by the control node grid-enabled software component to the client application.

33. The computer-program product according to claim 23 wherein the instructions configured to cause a data processing apparatus to assemble comprises instruction configured to cause a data processing apparatus to aggregate and concatenate the results of the analytical calculations performed with the processors at the worker nodes.
